(19) United States
(12) Patent Application Publication
(10) Pub. No.: US 2019/0051073 A1
(43) Pub. Date: Feb. 14, 2019

(54) SOFT BADGE-IN SYSTEM

(71) Applicant: Carrier Corporation, Palm Beach Gardens, FL (US)

(72) Inventor: Adam Kuenzi, Silverton, OR (US)

(21) Appl. No.: 16/077,293

(22) PCT Filed: Feb. 6, 2017
(86) PCT No.: PCT/US2017/016663

§ 371 Date: Aug. 10, 2018

Related U.S. Application Data
(60) Provisional application No. 62/294,014, filed on Feb. 11, 2016.

(51) Int. Cl. G07C 9/00

(52) U.S. Cl. CPC G07C 9/00309; G07C 9/00103; G07C 2009/00396; G07C 9/00571; G07C 9/00111

(57) ABSTRACT

A soft badge-in system includes a local entry device configured to wirelessly transmit an advertisement, and a mobile device carried by a human and configured to receive the advertisement. A computer-based server of the badge-in system is configured to receive a wireless identifier signal from the mobile device upon detection of the advertisement by the mobile device and indicative of a desire for entry. An event database is configured to receive a signal from the computer-based server indicative of entry status of the human. The soft badge-in system may further be configured to track the mobile device after entry to determine exit status.

### BACKGROUND

The present disclosure relates to a security access system and, more particularly, to a soft badge-in system utilizing a mobile device.

Many buildings and other structures must be secured in the sense that the identification and number of people entering and exiting a building at any given moment in time should be known. One known way in achieving this task is to assign a badge to all individuals requiring access. Each human is then required to perform a hard badge-in task at a reader located proximate to any entry point. In one example, the badge may be identified by the reading via a magnetic strip. Another example is reading a badge using RFID. Unfortunately, such a process requires each human to, for example, swipe their badge separately before entry is allowed. This task can be time consuming, and even if tail-gating through an open door by multiple individuals cannot be permitted by a policy of the organization, people may still tail-gate through a doorway. Also, while individuals are required to swipe their badge on entry, they are sometimes not required to swipe their badge on exit and thus, knowing their continued presence in a building is uncertain. Thus, there exists a need for a system where an individual can enter a building without swiping a badge, but still meet the policy for declaring their identity and presence in the building on entry and exit.

### SUMMARY

A soft badge-in system according to one, non-limiting, embodiment of the present disclosure includes a local entry device configured to wirelessly transmit an advertisement; a mobile device carried by a human and configured to receive the advertisement; a computer-based server configured to receive a wireless identifier signal from the mobile device upon detection of the advertisement by the mobile device and indicative of a desire for entry; and an event database configured to receive a signal from the computer-based server indicative of entry status of the human.

Additionally to the foregoing embodiment, the local entry device is proximate to an entry point.

In the alternative or additionally thereto, in the foregoing embodiment, the advertisement is an entry advertisement.

In the alternative or additionally thereto, in the foregoing embodiment, the computer-based server is configured to implement an access control system that is at least in-part software-based.

In the alternative or additionally thereto, in the foregoing embodiment, the access control system is an OnGuard Integrated Platform.

In the alternative or additionally thereto, in the foregoing embodiment, the computer-based server is configured to transmit a wireless permission signal to the mobile device indicative of entry permission status.

In the alternative or additionally thereto, in the foregoing embodiment, the mobile device is a cellular smart phone.

In the alternative or additionally thereto, in the foregoing embodiment, the mobile device includes a user screen configured to visually indicate the entry permission status to the human.

In the alternative or additionally thereto, in the foregoing embodiment, the mobile device is a cellular phone configured to produce an audible signal indicative of entry acceptance associated with the permission signal.

In the alternative or additionally thereto, in the foregoing embodiment, the local entry device includes a Bluetooth device configured to transmit a local entry device identifier to the mobile device as part of the advertisement.

In the alternative or additionally thereto, in the foregoing embodiment, the local entry device is one of a plurality of local entry devices.

In the alternative or additionally thereto, in the foregoing embodiment, the wireless identifier signal is indicative of the local entry device identifier and a mobile device identifier.

In the alternative or additionally thereto, in the foregoing embodiment the soft badge-in system includes a badge carried by the human, and wherein the local entry device is configured to read the hard badge and provide access permission.

In the alternative or additionally thereto, in the foregoing embodiment, the mobile device includes a satellite navigation receiver device for tracking the mobile device to determine exit status.

A computer implemented method of a soft badge-in tracking system includes determining an intent to enter and a local entry device identifier of a local entry device; sending a wireless signal by the mobile device to a computer-based server indicative of the local entry device identifier and a mobile device identifier of the mobile device; and transmitting a wireless permission signal by the computer-based server to the mobile device indicative of an access permission status.

Additionally to the foregoing embodiment, the method includes receiving the local entry device identifier by a mobile device.

In the alternative or additionally thereto, in the foregoing embodiment the method includes downloading the access permission status to an event database by the computer-based server.

In the alternative or additionally thereto, in the foregoing embodiment the method includes granting access permission; and indicating to the human by the mobile device of the granted access.

In the alternative or additionally thereto, in the foregoing embodiment the method includes checking an access policy by the computer based server to determine access permission.

In the alternative or additionally thereto, in the foregoing embodiment the method includes tracking the mobile device upon granting access permission and to determine exit status.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a diagram of a soft badge-in system applied to a building; and

FIG. 2 is a schematic of the soft badge-in system.

### DETAILED DESCRIPTION

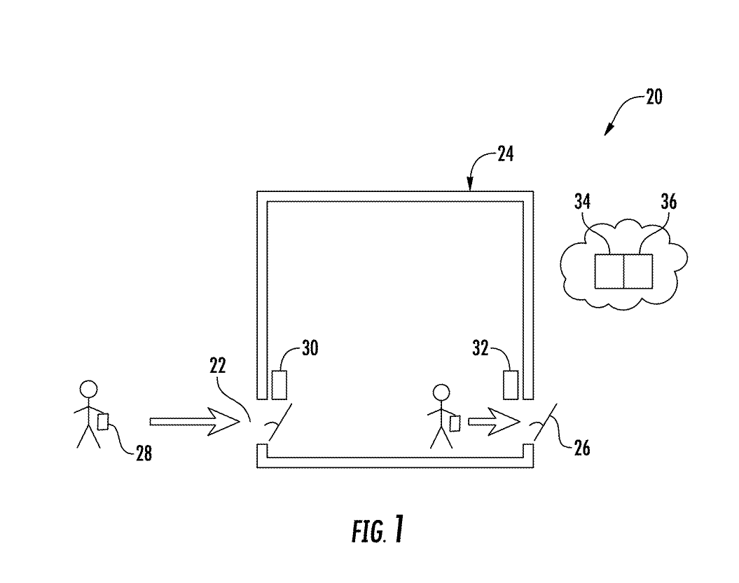

Referring to FIG. 1, a soft badge-in system 20 of the present disclosure facilitates at least entry permission of, for example, a human through an entry point 22 of, for example, a secured building 24, and may facilitate egress of the human through an exit point 26. The soft badge-in system 20 may generally store information indicative of who has entered the building 24 and when, who has exited the building 24 and when, and who remains in the building 24. The building 24 may contain multiple entry and exit points 22, 26, and the soft badge-in system 20 may recognize which points 22, 26 are used by which human. The soft badge-in system 20 may be configured to enhance (e.g., more convenient) the ability to enter and exit the building 24 while maintaining security protocols and policies of the organization managing the building 24.

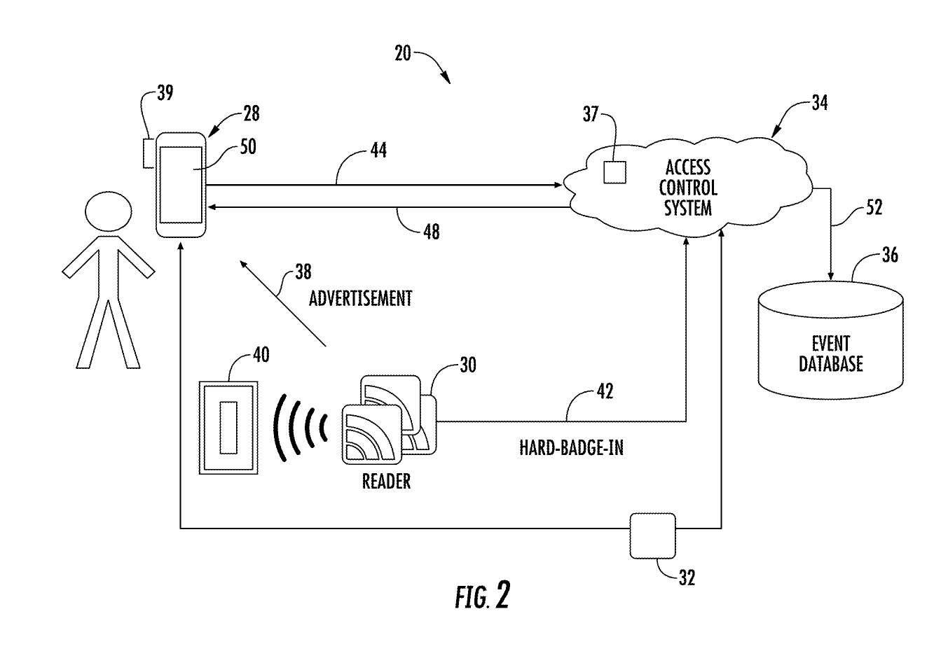

Referring to FIGS. 1 and 2, the soft badge-in system 20 may include a mobile device 28 carried by the human, an entry device 30, an exit device 32, a computer-based server 34 and an event database 36. The mobile device 28 may be a cellular phone and/or a smart phone, a smart watch, a tablet, or any other mobile electronic device and may receive and send wireless signals to the server 34. The computer-based server 34 may be remotely located from the building 24 and may generally be part of a cloud environment. The server 34 may be configured to download data sent from the mobile device 28 to the event database 36 and may additionally receive signals from the entry and exit devices 30, 32 associated with hard badge-in and hard badge-out events and also send these events to database 36. The server 34 and associated executable software may be part of an access control system deployed on premise inside the building or may be deployed and running in a computer in a cloud environment as an internet accessible service. One example of an access control system may be the OnGuard Integrated Platform by United Technologies Corporation. The server 34 may be comprised of multiple server components and software packages or it may be a single application. For example, one aspect of the server 34 may be to handle communications with the mobile device 28 and a separate aspect of the server 34 may be to handle communications from entry and exit devices 30 and 32. Further, another aspect of the server 34 may be the database 36 or the database 36 could be a separate system entirely, for example database 36 could be a time keeping system that tracks the amount of time that an employee works and needs to know when an employee started and stopped working. Another aspect of access control system and server 34 could be to determine a policy of whether a human is permitted entry into a building or permitted to use the soft-badge in system 20 to tail-gate with others into the building 24. And, another aspect of the access control system and server 34 could be an interface where an administrator can configure the policy of who (i.e., badge 40 or mobile device 28) is allowed into a particular entry point 22 or allowed to soft-badge in.

The access control system may include control circuitry such as a computer processor and a computer readable and writeable storage medium that may be, or include, the event database 36. The storage medium may include hard disk drive storage, nonvolatile memory (e.g., flash memory or other electrically-programmable-read-only memory configured to form a solid state drive), volatile memory (e.g., static or dynamic random-access-memory), and others. The processor and storage medium may be used to control and/or receive signals from any one or more of the devices 28, 30, 32. The processor may be based on one or more microprocessors, microcontrollers, digital signal processors, baseband processors, power management units, audio codec chips, application specific integrated circuits, and others.

The processor and/or server 34 may be used to run embedded and cloud server software such as internet browsing applications, voice-over-internet-protocol (VOIP) telephone call applications, email applications, media playback applications, operating system functions, and others. To support interactions with external equipment, the processor may be used in implementing communications protocols. Such communication protocols may include internet protocols, and wireless local area network protocols (e.g. WiFi®), protocols for other short-range wireless communications links such as the Bluetooth® protocol, cellular telephone protocols like CDMA, GSM and the like, and others.

The soft badge-in system 20 may further include wireless communications circuitry that may include radio-frequency (RF) transceiver circuit, power amplifier circuit, low-noise input amplifiers, passive RF components, at least one antenna, and other components for receiving and broadcasting RF wireless signals. The access control system may further include a positioning system 37 (FIG. 2), a wireless local area network transceiver circuit, cellular telephone transceiver circuit, and others. Non limiting examples for the wireless local area network transceiver circuit may include WiFi® and/or Bluetooth® protocols or other wireless communications protocols well known in the art.

The positioning system 37 is configured to determine positioning information indicative of a geographical position using one or more positioning systems or protocols of a type well known in the art, such as Global Positioning Systems (GPS), Global Navigation System (GLONASS), Global Navigation Satellite System (GNSS), Galileo, Long Range Navigation (LORAN), National Marine Electronics Association (NMEA), Trimble Standard Interface Protocol (TSIP), DELORME® EARTHMATE®, Rockwell PLGR Protocol, iBeacon®, and SIRF®, to name a few non-limiting examples. It will also be appreciated that positioning system 37 may include local, regional, or site-wide systems of a type well known in the art, such as radio frequency identification (RFID), infrared (IR), sensor networks, Wi-Fi-based positioning, and Ultra-Wideband (UWB) positioning systems, to name a few non-limiting examples. The positioning system 37 may work in conjunction with device 39 of the mobile device 28, and device 39 may be a Global Positioning System (GPS) receiver circuit, or circuitry associated with other satellite navigation systems. In any case, the positioning system 37 and device 39 work to determine the position of the mobile device 28 relative to the building 24. It will also be appreciated that the positioning information may include types well known in the arts such as, geographic latitude and longitude, Universal Transverse Mercator (UTM) and Universal Polar Stereographic (UPS) coordinates, stereographic coordinates, geodetic height, Cartesian coordinates, and street address, to name a few non-limiting examples.

The entry device 30 is configured to transmit a wireless signal 38 (i.e., Bluetooth advertisement) capable of being received by the mobile device 28 that is programmed with compatible software. The entry device 30 may be, or may include, a Bluetooth device capable of transmitting the advertisement 38. The advertisement 38 may include an entry device identifier. Each entry device 30 may generally be local with one entry device 30 located at each respective entry point 22. Each entry point 22 (or local device 30) may include a distinct identifier and may optionally include a shared identifier to indicate, for example, the particular building 24. The entry device 30 may be or include, for example, a reader and the entry point 22 may be a door. The reader 30 may generally be mounted to the door and may further include a lock mechanism (not shown) for locking the door 22 closed until entry is permitted by either a soft badge-in or hard badge-in event. Alternatively, there may be no lock feature and the soft badge-in system 20 may generally provide only an ‘access permission’ to enter, followed by a tracking feature until the human exits the building 24 via the exit point 26.

Referring to FIG. 2, in general, soft badge-in events are conducted via the mobile device 28, and hard badge-in events may be conducted utilizing more traditional mobile badges 40 that may include magnetic strips (not shown) capable of being read by the reader 30 (i.e., short range magnetic communication), as is typically known in the art of badge readers. There are many existing forms of mobile badges 40 that also include technologies like RFID, MIFARE®, iCLASS®, or other types of proximity based technologies where the badge may be read by the reader 30 via a short range RFID interface. In a hard badge-in event, the human may place the badge 40 close to reader 30, whereupon the reading of the badge 40 would result in directly granting access to the entry point 22.

The reader 30 may comprise a single device that grants access to a door, or it may comprise multiple devices where one aspect reads the badge 40 and another aspect controls the door and another aspect determines if badge 40 is allowed into entry point 22 and another aspect communicates the determination to the server 34. In all cases, the reader 30 may transmit a signal 42 over a wired or wireless pathway that may include the hard badge-in access grant event, and the access point 22 or reader 30 identifier. When the signal 42 is received by the server 34, the server may transmit or download data (see arrow 52) to the event database 36 indicative of the hard badge-in event. The hard badge-in capability of an entry device 30 may generally be an access back-up system should a human desiring access not have (and what may be a more convenient method) the mobile device 28 on their person, or if for some reason, the soft badge-in capability is inoperative.

During operation of the soft badge-in system 20, the local entry device 30 may transmit the advertisement 38 continuously or through a pattern of pulses. When the mobile device 28 is within a prescribed vicinity of the entry device 30, the mobile device 28 receives the advertisement and thus determines it is near (or within a proximal distance to) the entry device 30. The distance may be estimated based upon the received signal strength indicator (RSSI) from a single or multiple received advertisements. RSSI is not always precisely accurate, but if the advertisement is short-range (e.g., about thirty feet), the receipt of any advertisement at all may automatically indicate that the mobile device 28 is near the entry device 30, and may be used to automatically determine the human's intent to enter the building through the entry point 22. Limiting reception to the short-range distance may be accomplished by the entry device 30 transmitting advertisements at a low-power setting. With the advertisement transmitted at a low-power setting, the distance a mobile device 28 may receive the advertisement may be very close (e.g., about three feet). Alternatively, the mobile device 28 may determine a relative distance based on RSSI, and differentiate a short-range distance from a very-close distance. The determination of a very-close distance, may for example automatically indicate the human's intent to enter the building. Alternatively, after receiving the advertisement, the mobile device 28 may vibrate or make a sound or display an indication and the human could tap on the interactive touch-screen of the mobile device 28, or make a gesture with the device 28, or tap the device 28 and indicate their intent to enter, or to not enter, the building 24.

Alternatively, the intent to enter the building may be made by the human, for example by selecting a name of an entry point 22 or making some indication via touch-screen or data entry, on a display of the mobile device 28 that he/she desires to enter the building 24. Alternatively, the intent to enter the building may be made after a determination of the location of the mobile device 28 relative to the building 24 by the positioning system 37 and device 39 indicates that the mobile device 28 is now close to the building 24, and whereas it was not previously close to the building 24. Further, upon arriving at a building 24, the human may receive a prompt on the mobile device 28 to which they respond to and indicate that they really do want to enter the building 24. In any case, after determining a human's intent to enter the building 24, the mobile device 28 may then transmit a wireless signal 44 to the server 34 that may include both the entry device 30 identifier and a mobile device 28 identifier (i.e., indicative of the human identification desiring entry).

The server 34 may then process the signal 44 and make a determination of whether the human is permitted to soft-badge in at this entry point 22. The determination of whether a human is permitted to soft-badge in may be made by the server 34 checking a policy stored, for example, in the database 36 that indicates whether this human associated with mobile device 28 should be permitted. After making a determination, server 34 may transmit a wireless permission signal 48 back to the mobile device 28 that is indicative of an entry permission status (e.g., granted or denied). For instance, if access is granted, this grant may appear visually on a user screen 50 of the mobile device 28 and/or initiate an audible sound. Similarly, if access is denied, visual and/or audible indicators may be provided to the human desiring access via the mobile device 28. In one example, if the human is alerted that soft badge-in is denied, the human may still attempt a hard badge-in if the local entry device 30 is an appropriate reader and the human has the appropriate badge 40 on their human. Further, the access control system may send a signal to the local entry device 30 (not shown) after access is granted for a soft-badge in request so that the entry device may open the door associated with entry point 22.

Associated with the entry permission status, the server 34 may download (or transmit a signal 52) to the event database 36 indicative of a failed attempted access at a specific designated entry point 22 by a specific human, or an access grant thus evidence of a specific human entering the building 24 at a specific entry point 22.

In examples where it may be necessary to account for all humans in a building at any given time, the soft badge-in system 20 may also function as a tracking system. For example, the mobile device 28 via the positioning system 37 and device 39 may generally be tracked to determine if and when the human carrying the mobile device 28 leaves the building 24 and through which exit point 26. The determination of whether the human has left the building 24 may be accomplished by the mobile device 28, and sent as a message/signal 44 to the server 34, or the determination could be made by the server 34 directly based on information from the positioning system 37. In any case, this data may be downloaded into the event database 36 to ultimately track and account for all humans presently in the building at any given moment in time.

A non-limiting example of a positioning system 37 and device 39 that may provide this tracking capability include a GPS satellite network as the positioning system 37 and a GPS receiver circuit as device 39 that determines the location of the mobile device 28 and the mobile device 28 may send a message/signal 44 to the server 34 indicative of its location or of when it has moved significantly from an initial point and the movement indication determines that the human is no longer in the building 24.

Another non limiting example of a positioning system 37 is where a network of Bluetooth® devices may be sending short-range beacons or advertisements that may be received by the device 39. By comparing with a map of the building 24 and known locations of specific advertising devices, the mobile device 28 (or the server 34) may determine the location of the mobile device 28 relative to the advertising devices, and thus knows when the mobile device 28 has left the building.

Another example of tracking includes the positioning system 37 being a network of receivers that listen for transmissions from the device 39 on the mobile device 28. Depending on which receivers are capable of hearing the device 39 may determine the proximal location of the mobile device 28. When no receiver can hear the mobile device 28, the positioning system 37 may determine the mobile device 28 is no longer in the building 24.

Another example of tracking includes the positioning system 37 being multiple Bluetooth® devices located near each entry point 22 so that one device is outside the building 24 and another device is inside the building 24. Depending upon the relative received strength by the mobile device 28, it can be determined whether the mobile device 28 is inside the building or outside the building based on which device is closer. Moreover, by detecting progression from the inside to the outside, the mobile device 28 may indicate to the server 34 that it has left the building 24. It should be appreciated that these examples are non-limiting and there are other methods of determining the location of the mobile device 28 relative to the building 24. In any case, the server 34 may, based on the location of the mobile device 28, determine if the human has left the building 24.

It is further contemplated and understood that each entry point 24 may also be the exit point 26. Similarly, the entry devices 30 may be integrated along with the exit devices 32. Further, it is contemplated and understood that the various methods of determining whether a human is intending to enter a building may also apply to determining if they intend to exit a building and thus the method for soft-badge in may include the human's indicated intent to exit the building and in some examples the intent is automatically determined and in other examples it is explicitly specified by the human using the mobile device 28.

Advantages and benefits of the present disclosure include a convenient way for humans to access a secured building that may allow humans to ‘tail gate’ through an open door where, otherwise, separate hard badge-in events for each human would have to occur. Other advantages include an automatic means to determine who has entered a secured building without the individual desiring access having to perform any special task (e.g., swiping a badge, etc.).

While the present disclosure is described with reference to illustrated embodiments, it will be understood by those skilled in the art that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

What is claimed is:

1. A soft badge-in system comprising:
a local entry device configured to wirelessly transmit an advertisement;
a mobile device carried by a human and configured to receive the advertisement;
a computer-based server configured to receive a wireless identifier signal from the mobile device upon detection of the advertisement by the mobile device and indicative of a desire for entry; and
an event database configured to receive a signal from the computer-based server indicative of entry status of the human.

2. The soft badge-in system set forth in claim 1, wherein the local entry device is proximate to an entry point.

3. The soft badge-in system set forth in claim 2, wherein the advertisement is an entry advertisement.

4. The soft badge-in system set forth in claim 3, wherein the computer-based server is configured to implement an access control system that is at least in-part software-based.

5. The soft badge-in system set forth in claim 4, wherein the access control system is an OnGuard Integrated Platform.

6. The soft badge-in system set forth in claim 3, wherein the computer-based server is configured to transmit a wireless permission signal to the mobile device indicative of entry permission status.

7. The soft badge-in system set forth in claim 1, wherein the mobile device is a cellular smart phone.

8. The soft badge-in system set forth in claim 6, wherein the mobile device includes a user screen configured to visually indicate the entry permission status to the human.

9. The soft badge-in system set forth in claim 6, wherein the mobile device is a cellular phone configured to produce an audible signal indicative of entry acceptance associated with the permission signal.

10. The soft badge-in system set forth in claim 2, wherein the local entry device includes a Bluetooth device configured to transmit a local entry device identifier to the mobile device as part of the advertisement.

11. The soft badge-in system set forth in claim 10, wherein the local entry device is one of a plurality of local entry devices.

12. The soft badge-in system set forth in claim 10, wherein the wireless identifier signal is indicative of the local entry device identifier and a mobile device identifier.

13. The soft badge-in system set forth in claim 1 further comprising:
a badge carried by the human, and wherein the local entry device is configured to read the hard badge and provide access permission.

14. The soft badge-in system set forth in claim 1, wherein the mobile device includes a satellite navigation receiver device for tracking the mobile device to determine exit status.

15. A computer implemented method of a soft badge-in tracking system comprising:
determining an intent to enter and a local entry device identifier of a local entry device;
sending a wireless signal by the mobile device to a computer-based server indicative of the local entry device identifier and a mobile device identifier of the mobile device; and
transmitting a wireless permission signal by the computer-based server to the mobile device indicative of an access permission status.

16. The method set forth in claim 15 further comprising:
receiving the local entry device identifier by a mobile device.

17. The method set forth in claim 16 further comprising:
downloading the access permission status to an event database by the computer-based server.

18. The method set forth in claim 17 further comprising:
granting access permission; and
indicating to the human by the mobile device of the granted access.

19. The method set forth in claim 18 further comprising:
checking an access policy by the computer based server to determine access permission.

20. The method set forth in claim 18 further comprising:
tracking the mobile device upon granting access permission and to determine exit status.
